(19) United States
(12) Patent Application Publication
(10) Pub. No.: US 2011/0109822 A1
(43) Pub. Date: May 12, 2011

(54) LIQUID CRYSTAL DISPLAY ELEMENT, METHOD OF MANUFACTURING THE SAME, AND LIQUID CRYSTAL DISPLAY DEVICE

(75) Inventors: Takuto Kato, Seto (JP); Toshiaki Yoshihara, Kawasaki (JP); Yoshihisa Kurosaki, Kawasaki (JP)

(73) Assignee: FUJITSU LIMITED, Kawasaki-shi (JP)

(21) Appl. No.: 12/942,173

(22) Filed: Nov. 9, 2010

(30) Foreign Application Priority Data
Nov. 12, 2009 (JP) 2009-259194

(51) Int. Cl. G02F 1/133; H01J 9/00

(52) U.S. Cl. 349/33; 445/24

(57) ABSTRACT

A liquid crystal display element includes: a liquid crystal layer including liquid crystal material reflecting light having a certain wavelength; and an electrode layer configured to apply a driving voltage to the liquid crystal material, wherein an alignment direction of first liquid crystal molecules of the liquid crystal material is a first direction substantially parallel to a liquid crystal display surface.

### CROSS-REFERENCE TO RELATED APPLICATIONS

This application claims the benefit of priority from Japanese Patent Application No. 2009-259194 filed on Nov. 12, 2009, the entire contents of which are incorporated herein by reference.

### BACKGROUND

1. Field

Embodiments discussed herein relate to a liquid crystal display element, a method of manufacturing the liquid crystal display element, and a liquid crystal display device.

2. Description of Related Art

A reflective type liquid crystal display element includes a liquid crystal layer in which cholesteric liquid crystals are enclosed. The liquid crystal layer is sandwiched between a pair of substrates. By applying a certain driving voltage to the liquid crystal layer, arrangement of liquid crystal molecules of the liquid crystal layer is controlled and incident external light is modulated, thereby displaying an image.

Related art is disclosed in Japanese Laid-open Patent Publication No. H10-48600, Japanese Laid-open Patent Publication No. 2001-117109 or Japanese Laid-open Patent Publication No. 2001-311952.

### SUMMARY

According to one aspect of the embodiments, a liquid crystal display element includes: a liquid crystal layer including liquid crystal material reflecting light having a certain wavelength; and an electrode layer configured to apply a driving voltage to the liquid crystal material, wherein an alignment direction of first liquid crystal molecules of the liquid crystal material is a first direction substantially parallel to a liquid crystal display surface.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary liquid crystal display element.

FIG. 2 illustrates an exemplary liquid crystal display element.

FIG. 3 illustrates an exemplary liquid crystal layer.

FIG. 4 illustrates an exemplary liquid crystal layer.

FIG. 5 illustrates an exemplary method of manufacturing a liquid crystal display element.

FIGS. 6A to 6F illustrate an exemplary method of manufacturing a liquid crystal display element.

FIG. 7 illustrates an exemplary photomask.

FIG. 8 illustrates an exemplary film substrate.

FIG. 9 illustrates an exemplary film substrate.

FIG. 10 illustrates an exemplary film substrate.

FIG. 11 illustrates an exemplary film substrate.

FIG. 12 illustrates an exemplary reflectivity.

FIG. 13 illustrates an exemplary contrast ratio.

FIG. 14 illustrates an exemplary liquid crystal display element.

FIG. 15 illustrates an exemplary wrapping process.

FIG. 16 illustrates an exemplary liquid crystal display element.

FIG. 17 illustrates an exemplary alignment direction of liquid crystal molecules.

FIGS. 18A to 18C illustrate an exemplary photomask and an exemplary liquid crystal layer.

FIG. 19 illustrates an exemplary rubbing process.

FIGS. 20A and 20B illustrate an exemplary liquid crystal display element.

### DESCRIPTION OF EMBODIMENTS

Cholesteric liquid crystals in a liquid crystal layer include liquid crystal molecules having a spiral structure, and the cholesteric liquid crystals transition to a planar state, a focal conic state, or the like when a driving voltage or the like is applied. The light permeability and reflectivity of the cholesteric liquid crystals in the planar state are different from the light permeability and reflectivity of the cholesteric liquid crystals in the focal conic state. In a liquid crystal display element including cholesteric liquid crystals, light permeability and reflectivity vary according to the applied voltage, and the displayed content varies.

Even when a voltage is not applied to the cholesteric liquid crystals in the planar state or the focal conic state, the display state becomes stable and power consumption may be reduced. In addition, since the cholesteric liquid crystals may include a reflection state, a polarization plate or a color filter may not be used. Therefore, a bi-stable mode using the planar state and the focal conic state may be set.

When the reflectivity of the planar state is not high, a display may become dark. When the contrast ratio between the planar state and the focal conic state is not high, the display may become unclear.

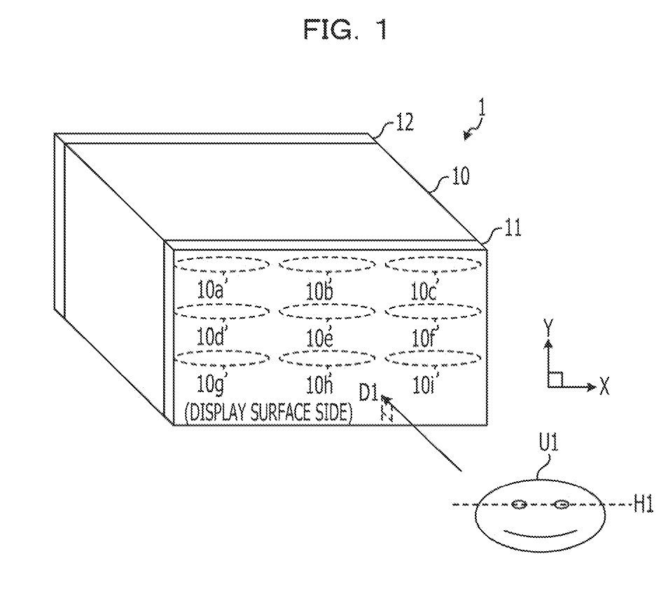

FIG. 1 illustrates an exemplary liquid crystal display element. The liquid crystal display element 1 illustrated in FIG. 1 may be applied to a liquid crystal display device using liquid crystal material that reflects light of specific wavelengths.

The liquid crystal display element 1 includes a liquid crystal layer 10 and electrode layers 11 and 12. The liquid crystal layer 10 is sandwiched between the electrode layer 11 and the electrode layer 12, and a driving voltage for display control is applied to the liquid crystal layer 10. The display surface of the liquid crystal display element 1 may be provided, for example, on the side of the electrode layer 11.

A user U1 may view, for example, a liquid crystal display device including the liquid crystal display element 1 from a constant direction. The user U1 may view, for example, the liquid crystal display element 1 from a direction substantially perpendicular to the display surface without rotating the liquid crystal display device. For example, in FIG. 1, the visual line D1 of the user U1 may be substantially perpendicular to the display surface.

The liquid crystal layer 10 includes liquid crystal material reflecting light of specific wavelengths. The liquid crystal layer 10 may be arranged so that alignment direction of the liquid crystal molecules near the interface with the electrode layer 11 or the electrode layer 12 is substantially parallel to a binocular direction H1 linking both eyes of a user viewing the display surface. For example, in FIG. 1, the liquid crystal layer 10 is arranged so that the alignment direction of the liquid crystal molecules 10a to 10i near the interface with the electrode layer 11 is substantially parallel to the binocular direction H1. The alignment direction indicates the direction of the molecular axis of a liquid crystal molecule, for example, the major axis direction (longitudinal direction) of the liquid crystal molecule. In the subsequent figures, in order to clarify the description, the liquid crystal molecules may be enlarged.

Since the reflectivity of the liquid crystals is increased in the direction perpendicular to the major axis directions of the liquid crystal molecules, the alignment direction of the liquid crystal molecules is arranged so as to be substantially parallel to the binocular direction H1. For example, as illustrated in FIG. 1, when the alignment direction of the liquid crystal molecules 10a to 10i is substantially parallel to the binocular direction H1, the reflectivity to the user U1 of the liquid crystal molecules 10a to 10i may be increased in the planar state. Therefore, if the alignment direction of the liquid crystal molecules 10a to 10i is substantially parallel to the binocular direction H1, the display of the liquid crystal element 1 may become brighter.

When the alignment direction of the liquid crystal molecules 10a to 10i is substantially parallel to the binocular direction H1, the reflectivity of the liquid crystal molecules 10a to 10i may not vary to the user U1 in the focal conic state. In the liquid crystal display element 1 illustrated in FIG. 1, a difference between the reflectivity of the planar state and the reflectivity of the focal conic state may be increased. Since the contrast ratio of the liquid crystal display element 1 illustrated in FIG. 1 is high, the display may become clear.

The reflectivity and the contrast ratio of the planar state of the liquid crystal display element 1 illustrated in FIG. 1 may be increased. In the liquid crystal display element 1 illustrated in FIG. 1, the visibility for the user may be improved.

In FIG. 1, the alignment direction of the liquid crystal molecules located near the interface between the liquid crystal layer 10 and the electrode layer 11 is substantially parallel to the binocular direction H1. For example, the alignment direction of the liquid crystal molecules located near the interface between the liquid crystal layer 10 and the electrode layer 12 may be substantially parallel to the binocular direction H1. Both the liquid crystal molecules located near the interface between the liquid crystal layer 10 and the electrode layer 11 and the liquid crystal molecules located near the interface between the liquid crystal layer 10 and the electrode layer 12 are substantially parallel to the binocular direction H1.

The viewing direction of the user U1 may be predicted based on the display direction or the shape of the liquid crystal display device. For example, when the direction of a display target displayed by the liquid crystal display element 1 is decided in advance, the user U1 may view the liquid crystal display device from a direction substantially perpendicular to the display surface without rotating the liquid crystal display device. For example, in FIG. 1, the horizontal direction of the display target displayed by the liquid crystal display element 1 may be the X direction illustrated in FIG. 1 and the vertical direction of the display target may be the Y direction illustrated in FIG. 1. In this case, the user may view the liquid crystal display device without rotating the liquid crystal display device.

When the viewing direction of the user is predicted, the liquid crystal display element 1 may be manufactured so that the alignment direction of the liquid crystal molecules and the binocular direction H1 are substantially parallel to each other. The visibility of the manufactured liquid crystal display element 1 for the user may be improved.

The alignment direction of the liquid crystal molecules may be defined by a given structure of the liquid crystal layer. As liquid crystals, cholesteric liquid crystals and chiral nematic liquid crystals obtained by adding a chiral agent to nematic liquid crystals may be used.

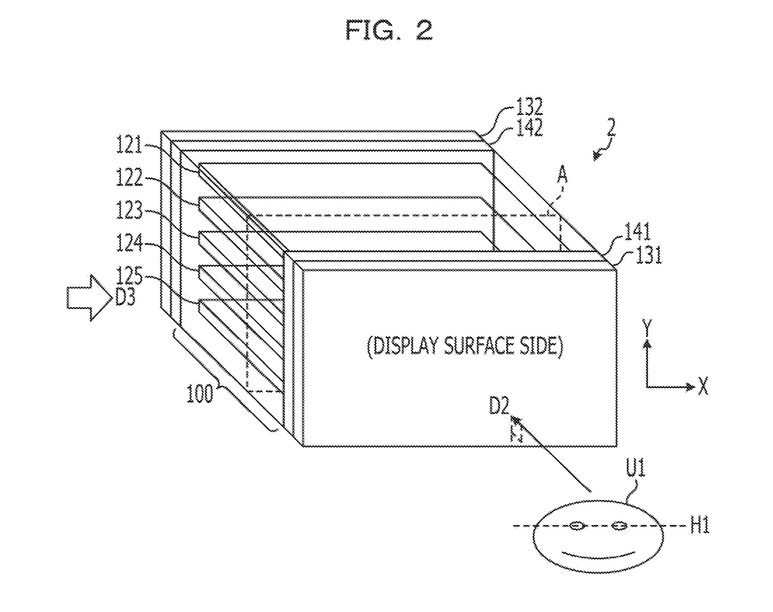

FIG. 2 illustrates an exemplary liquid crystal display element. The liquid crystal display element 2 illustrated in FIG. 2 includes a liquid crystal layer 100, film substrates 131 and 132, and electrode layers 141 and 142. In FIG. 2, a display surface of the liquid crystal display element 2 may be arranged on the film substrate 131 side.

The film substrates 131 and 132 illustrated in FIG. 2 may be transparent substrates made of glass, resin, or the like, and include the electrode layer 141, the liquid crystal layer 100, and the electrode layer 142 sandwiched between the film substrates. In the electrode layers 141 and 142, an electrode pattern may be patterned in advance and the liquid crystal layer 100 may be sandwiched between the electrode layers.

Cholesteric liquid crystals are enclosed in the liquid crystal layer 100. As illustrated in FIG. 2, the liquid crystal layer 100 includes structures 121 to 125. The structures 121 to 125 may be photoresists. As illustrated in FIG. 2, the structures 121 to 125 may be formed with a certain gap between the structures in a direction perpendicular to the binocular direction H1 of the user U1. The structures 121 to 125 may be formed in a direction substantially parallel to the binocular direction H1. Although five structures 121 to 125 are included in the liquid crystal layer 100 in FIG. 2, six or more structures may be included in the liquid crystal layer 100.

In the liquid crystal layer 100 illustrated in FIG. 2, the cholesteric liquid crystal may be injected from the direction D3 parallel to the binocular direction H1. The injected cholesteric liquid crystal flows between the structures 121 to 125 so as to be filled in the liquid crystal layer 100. For example, the cholesteric liquid crystal flows between the structure 121 and the structure 122 so as to be filled between the structure 121 and the structure 122. The cholesteric liquid crystal flows between the structure 122 and the structure 123 so as to be filled between the structure 122 and the structure 123.

When the cholesteric liquid crystals are injected, the flow direction of the cholesteric liquid crystals and the alignment direction of the liquid crystal molecules included in the cholesteric liquid crystals may be substantially equal or similar. The flow direction of the cholesteric liquid crystals and the major axis direction (molecular axis directions) of the liquid crystal molecules may be substantially equal or similar. For example, in FIG. 2, the alignment direction of the liquid crystal molecules included in the liquid crystal layer 100 is substantially equal to the flow direction of the cholesteric liquid crystals and thus is substantially parallel to the binocular direction H1 linking both eyes of the user.

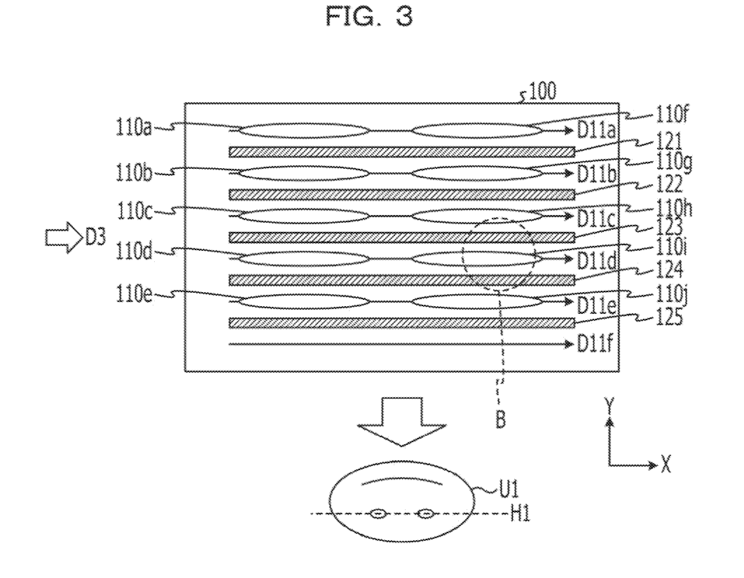

FIG. 3 illustrates an exemplary liquid crystal layer. FIG. 3 may be a cross-sectional view of a plane A of the liquid crystal layer 100 illustrated in FIG. 2. As illustrated in FIG. 3, the liquid crystal layer 100 includes the structures 121 to 125. In the liquid crystal layer 100, the cholesteric liquid crystals may be injected from a direction D3. For example, the flow direction of the cholesteric liquid crystals may be directions D11a to 11f illustrated in FIG. 3. The alignment direction of the liquid crystal molecules 110a to 110j included in the liquid crystal layer 100 may be substantially equal to the flow direction D11a to 11f of the cholesteric liquid crystals, as illustrated in FIG. 3.

The alignment direction of the liquid crystal molecules 110a to 110j may be substantially parallel to the binocular direction H1. For example, the alignment direction of the liquid crystal molecules 110a to 110j may be substantially horizontal directions when viewed from the perspective of the user U1. In the liquid crystal display element 2 illustrated in FIG. 2, since the reflectivity and the contrast ratio of the planar state are increased, visibility for the user may be improved.

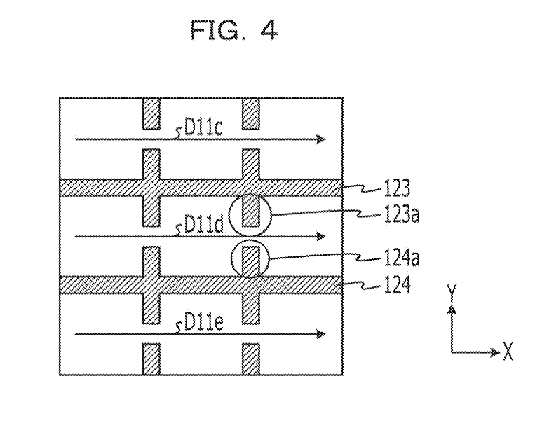

Although the structures 121 to 125 are planes in FIGS. 2 and 3, the structures 121 to 125 may not be planes. FIG. 4 illustrates an exemplary liquid crystal. FIG. 4 is an enlarged view of a region B illustrated in FIG. 3. In FIG. 4, for example, the structure 123 may include a region 123a protruding in the Y direction. For example, the structure 124 may include a region 124a protruding in the Y direction. The region 123a and the region 124a of the structures 121 to 125 included in the liquid crystal layer 100 illustrated in FIG. 2 may not be adhered. Therefore, as illustrated in FIG. 4, when the structures 121 to 125 include protruding regions, the cholesteric liquid crystal flows along the flow direction D11d when being injected into the liquid crystal layer 100.

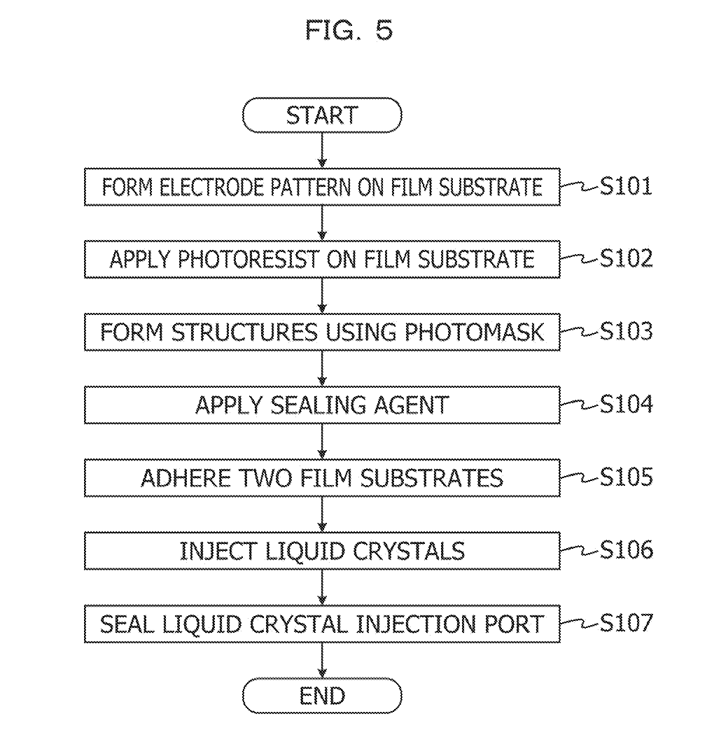

FIG. 5 illustrates an exemplary method of manufacturing a liquid crystal display device. The liquid crystal display device manufactured according to the manufacturing method illustrated in FIG. 5 may be the liquid crystal display element 2 illustrated in FIG. 2. As illustrated in FIG. 5, in an operation 101, a transparent conductive film is formed on the surface of a film substrate so as to form an electrode pattern. An electrode layer is formed on the film substrate. Electrode patterns of at least two film substrates are formed.

In an operation 102, a photoresist is formed by a spinner on one of the two film substrates on which the electrode layers are formed. In an operation 103, a structure defining the flow direction of the cholesteric liquid crystals is formed on the film substrate, on which the photoresist is formed, using a photomask. The structure may be formed such that the flow direction of the cholesteric liquid crystals is substantially parallel to the binocular direction H1.

In an operation 104, a spacer is formed on the other film substrate and a sealing agent is applied on the other film substrate. A liquid crystal injection port for injecting liquid crystals is formed in a seal wall formed along the sealing agent. In an operation 105, the film substrate on which the sealing agent is applied and the other film substrate are adhered to each other. The spacer or the sealing agent may be adhered to the other film substrate. Both the film substrates may be pressed and adjusted to fit in between a specified gap.

In an operation 106, cholesteric liquid crystals are injected from the liquid injection port by a vacuum injection method or the like. In an operation 107, the liquid injection port is sealed by a sealing agent or the like. A single-color liquid crystal panel is formed. When a three-layer lamination type liquid crystal display element is formed, the operations S101 to S107 are performed on each of a liquid crystal display element selectively reflecting blue light, a liquid crystal display element selectively reflecting green light, and a light crystal display element selectively reflecting red light. For example, the blue, green, and red liquid crystal display elements may be laminated from a display surface in this order.

The operations S101 to S107 illustrated in FIG. 5 may be performed by one manufacturing apparatus or a plurality of manufacturing apparatuses. For example, the operations S101 to S107 may be performed by different manufacturing apparatuses. After a manufacturing apparatus 1A performs the operations S101 to S103, a manufacturing apparatus 1B may perform the operations S104 to S107.

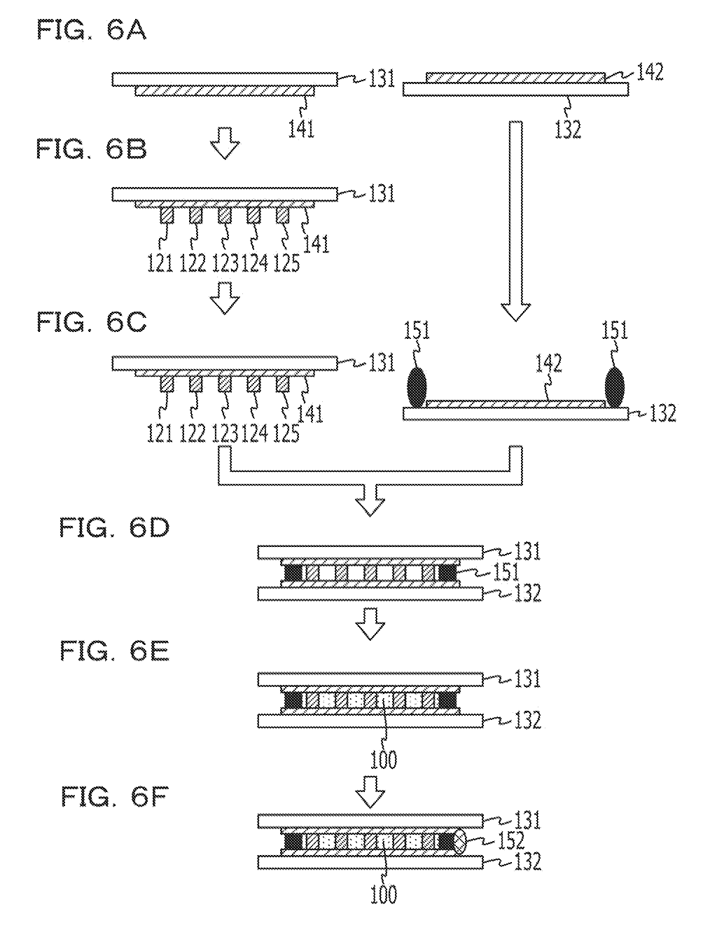

FIGS. 6A to 6F illustrate an exemplary method of manufacturing a liquid crystal display element. The liquid crystal display device manufactured by the manufacturing method illustrated in FIG. 6 may be the liquid crystal display device 2 illustrated in FIG. 2. FIGS. 6A to 6F may be diagrams when viewed from the direction D3 illustrated in FIG. 2. The upper side of FIG. 6 may be the display surface side.

As illustrated in FIG. 6A, a transparent conductive film is formed on a surface of a film substrate 131 so as to form an electrode layer 141. An electrode layer 142 is formed on a film substrate 132. In FIG. 6A, for passive driving, electrodes may be formed on the film substrate 131 and the film substrate 132 so that the electrode layer 141 and the electrode layer 142 are perpendicular to each other. The film substrates 131 and 132 may be, for example, film substrates formed of polyethylene terephthalate with a thickness of about 100 μm.

Structures setting the flow direction of cholesteric liquid crystals are formed on at least one of the film substrate 131 and the film substrate 132. In FIG. 6B, for example, after a photoresist such as an acrylic negative resist is formed on the film substrate 131, the structures are formed using a photomask.

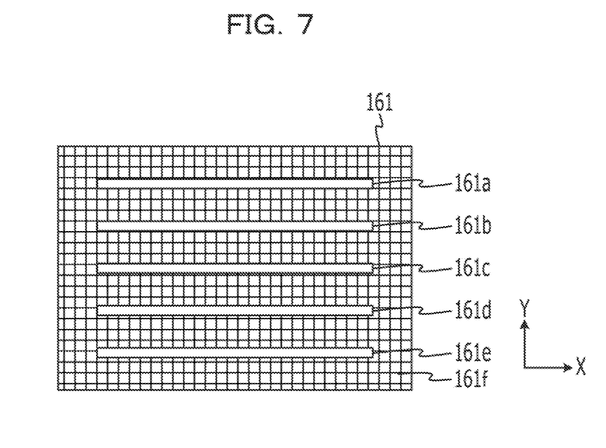

FIG. 7 illustrates an exemplary photomask. As illustrated in FIG. 7, the photomask 161 includes light transmission portions 161a to 161e and a light shielding portion 161f. The light transmission portions 161a to 161e transmit externally irradiated light. The light shielding portion 161f shields externally irradiated light.

For example, as illustrated in FIG. 6A, the photomask 161 is arranged on a plane of the film substrate 131, on which the photoresist is formed, with a certain gap between them. The photomask 161 may be arranged so that the major axis directions of the light transmission portions 161a to 161e are substantially parallel to the binocular direction H1. In this arrangement state, with respect to the photomask 161, light is irradiated in the direction from the photomask 161 to the film substrate. The photoresist located below the transmission portions 161a to 161e of the photoresist formed on the film substrate is adhered to the film substrate.

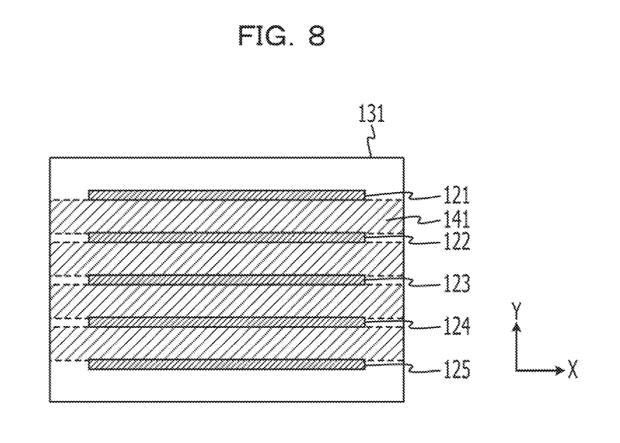

As illustrated in FIG. 6B, structures 121 to 125 including the photoresist are adhered on the electrode layer 141 of the film substrate 131. FIG. 8 illustrates an exemplary film substrate. FIG. 8 may be, for example, a diagram of the film substrate 131 illustrated in FIG. 6B when viewed from a lower side. As illustrated in FIG. 8, the structures 121 to 125 are formed with a specified gap between them in a direction perpendicular to the binocular direction H1 and are formed so as to be substantially parallel to the binocular direction H1.

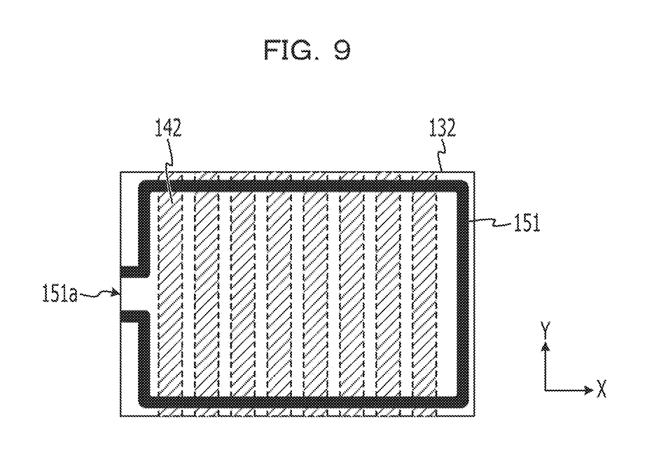

As illustrated in FIG. 6C, a sealing agent 151 is applied on the film substrate 132. FIG. 9 illustrates an exemplary film substrate. FIG. 9 may be a diagram of the film substrate 132 illustrated in FIG. 6C when viewed from an upper side. As illustrated in FIG. 9, the sealing agent 151 is applied in the vicinities of edges on the plane of the film substrate 132. The sealing agent 151 may not be applied to parts of the vicinities of the edges of the film substrate 132. A liquid crystal injection port 151a is formed.

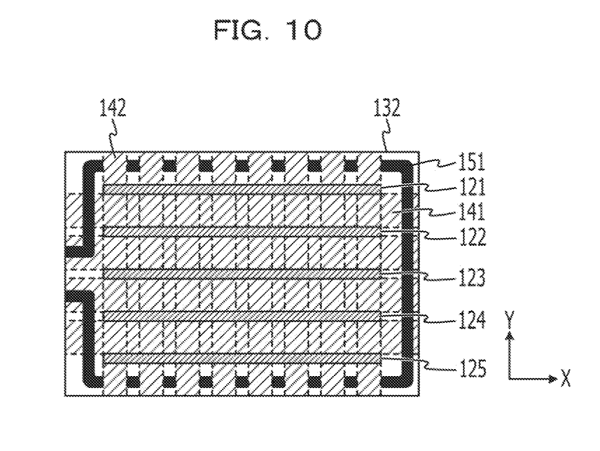

As illustrated in FIG. 6D, the film substrate 131 and the film substrate 132 are adhered by heating or pressurizing. FIG. 10 illustrates an exemplary film substrate. FIG. 10 may be a diagram of the film substrates 131 and 132 illustrated in FIG. 6D when viewed from an upper side. In FIG. 10, the film substrate 131 may not be illustrated. As illustrated in FIG. 10, when the film substrate 131 and the film substrate 132 are adhered, the electrode layer 141 and the electrode layer 142 may be perpendicular to each other.

As illustrated in FIG. 6E, cholesteric liquid crystals are injected into the liquid crystal layer 100 formed between the film substrate 131 and the film substrate 132. As illustrated in FIG. 6F, the liquid injection port is sealed by a sealing agent 152 or the like.

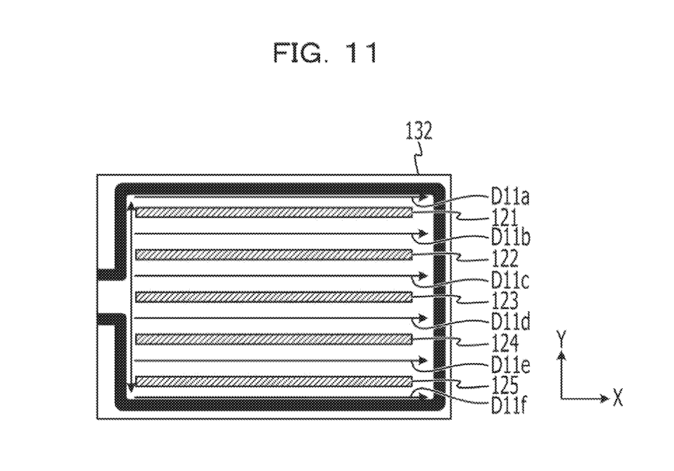

For example, in a vacuum state, the film substrates 131 and 132 illustrated in FIG. 6D are immersed in cholesteric liquid crystals and exposed to the atmosphere such that cholesteric liquid crystals are injected into the liquid crystal layer 100. FIG. 11 illustrates an exemplary film substrate. FIG. 11 may be a diagram of the film substrates 131 and 132 illustrated in FIG. 6E when viewed from an upper side. In FIG. 11, the film substrate 121 and the electrode layers 141 and 142 may not be displayed. As illustrated in FIG. 11, the cholesteric liquid crystals flow between the structures 121 to 125 so as to be injected into the liquid crystal layer 100. The cholesteric liquid crystals flow along the flow direction D11a to 11f illustrated in FIG. 11.

The liquid crystal display element 2 illustrated in FIG. 2 is controlled so that the flow direction of the cholesteric liquid crystals at the time of injection is substantially parallel to the binocular direction H1 of the user U1 due to the structures included in the liquid crystal layer 100. Therefore, the alignment direction of the liquid crystal molecules included in the liquid crystal layer 100 is substantially parallel to the binocular direction H1. The display of the liquid crystal display element 2 illustrated in FIG. 2 becomes brighter. Since the contrast ratio of the liquid crystal display element 2 illustrated in FIG. 2 is high, the display may become clear.

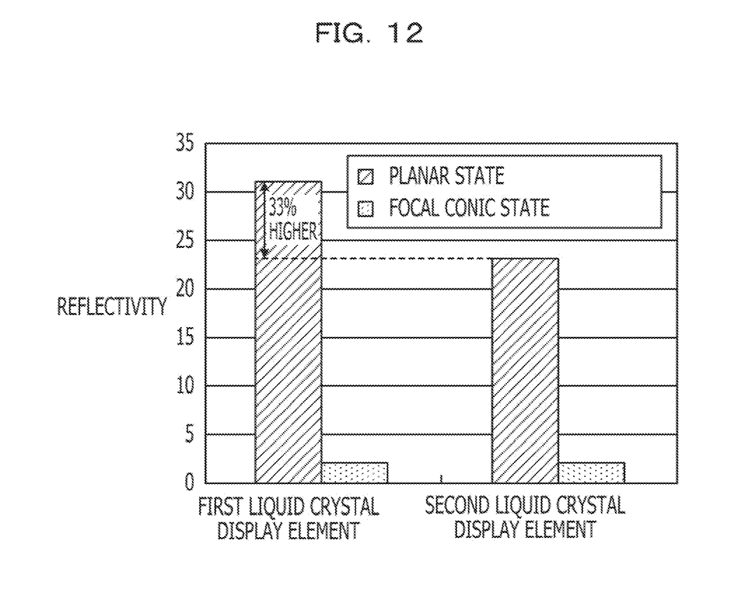

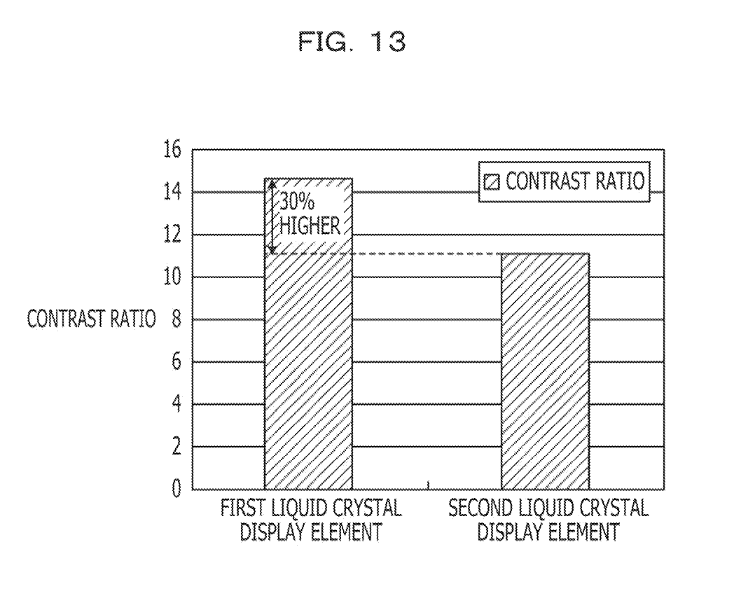

FIG. 12 illustrates an exemplary reflectivity. FIG. 12 illustrates the reflectivity of the first liquid crystal display element 2 illustrated in FIG. 2, and another second liquid crystal display element. FIG. 13 illustrates an exemplary contrast ratio. FIG. 13 illustrates the contrast ratios of the first liquid crystal display element 2 illustrated in FIG. 2, and another second liquid crystal display element. As illustrated in FIG. 12, in the planar state, the reflectivity of the first liquid crystal display element 2 is higher than the reflectivity of the second liquid crystal display element by about 33%. As illustrated in FIG. 12, in the focal conic state, the reflectivity of the first liquid crystal display element 2 and the reflectivity of the second liquid crystal display element are substantially equal to each other. As illustrated in FIG. 13, the contrast ratio of the first liquid crystal display element 2 is higher than the contrast ratio of the second liquid crystal display element by about 30%.

Since the reflectivity and the contrast ratio of the first liquid crystal display element 2 are higher than the reflectivity and the contrast ratio of the second liquid crystal display element, the display becomes bright and clear.

The liquid crystal layer is sandwiched between the electrode layers 141 and 142. For example, the liquid crystal display element may include an alignment film.

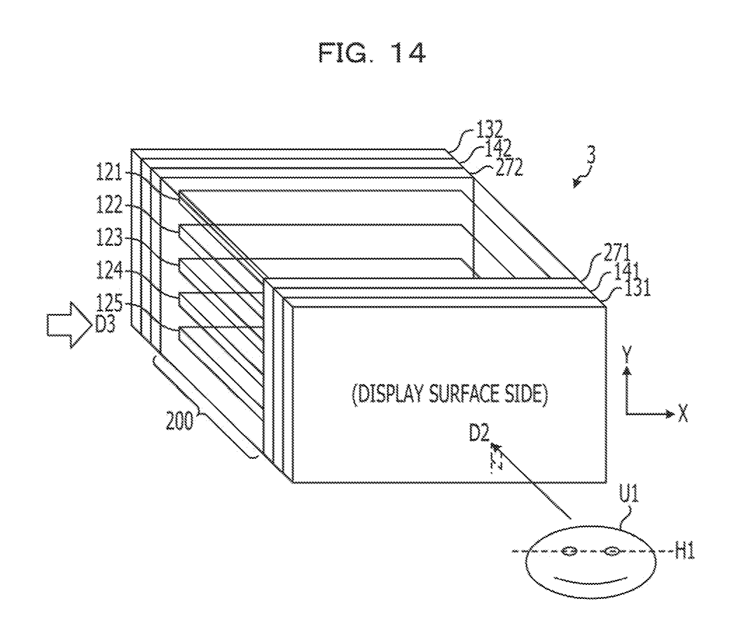

FIG. 14 illustrates an exemplary liquid crystal display element. In FIG. 14, the elements that are substantially the same as the elements illustrated in FIG. 2 are denoted by the same reference numerals and the description thereof may be omitted or abbreviated.

The liquid crystal display element 3 illustrated in FIG. 14 includes a liquid crystal layer 200, film substrates 131 and 132, electrode layers 141 and 142, and alignment films 271 and 272. In the liquid crystal display element 3 illustrated in FIG. 14, the film substrate 131 side may be a display surface.

The alignment films 271 and 272 may include a polyimide resin. The alignment film 271 is formed on the electrode layer 141 in a manufacturing operation. The alignment film 272 is formed on the electrode layer 142. In the alignment films 271 and 272 formed on the electrode layers 141 and 142, a rubbing process is performed in a binocular direction H1 and a horizontal direction. When cholesteric liquid crystals are injected into the liquid crystal layer 200, the alignment direction of liquid crystal molecules may be substantially equal to the rubbing direction.

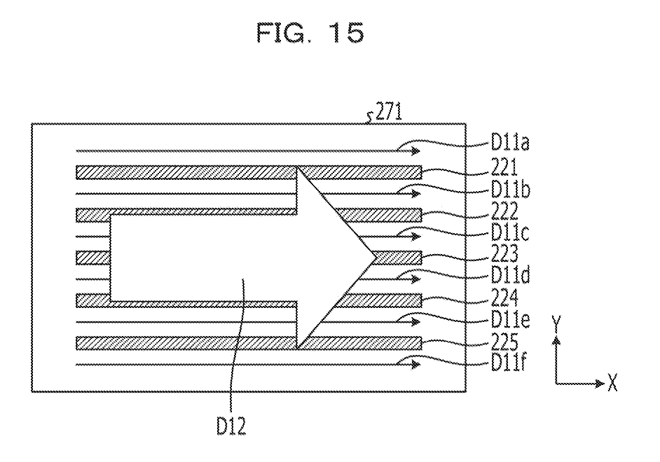

FIG. 15 illustrates an exemplary wrapping process. The wrapping process illustrated in FIG. 15 may be performed on the alignment films illustrated in FIG. 14. The alignment film 272 illustrated in FIG. 15 may be a diagram viewed in the viewing direction of an arrow D2 illustrated in FIG. 14. As illustrated in FIG. 15, the rubbing process is performed on the alignment film 272 in the rubbing direction D12, which is substantially parallel to the binocular direction H1. The rubbing process is performed on the alignment film 271 in the rubbing direction D12.

In the manufacture of the liquid crystal display element 3 illustrated in FIG. 14, after the operation S101 illustrated in FIG. 5, a polyimide resin is, for example, formed on the electrode films formed on the film substrates 131 and 132 by a spinner. The rubbing process is performed on the polyimide resin film so as to form the alignment films 271 and 272. Thereafter, the operations S102 to S107 illustrated in FIG. 5 may be performed.

In the liquid crystals injected into the liquid crystal layer 200, the alignment direction of the liquid crystal molecules is controlled so as to be parallel to the binocular direction H1 by the alignment films 271 and 272 which are subjected to the rubbing process in the direction parallel to the binocular direction H1. Since the liquid crystals injected into the liquid crystal layer 200 flow between the structures 121 to 125, the alignment direction of the liquid crystal molecules is substantially parallel to the binocular direction H1. For example, the alignment direction of the liquid crystal molecules of the liquid crystal layer 200 illustrated in FIG. 14 may be parallel to the binocular direction H1 according to the flow direction of the liquid crystals and the alignment films 271 and 272. The reflectivity and the contrast ratio of the planar state of the liquid crystal display element 3 illustrated in FIG. 14 may be further increased.

By performing the rubbing process on the alignment films, the alignment direction of the liquid crystal molecules injected into the liquid crystal layer 200 is controlled. By performing an optical alignment process on the alignment films, the alignment direction of the liquid crystal molecules injected into the liquid crystal layer 200 may be controlled so as to be substantially parallel to the binocular direction H1.

Since the alignment direction of the liquid crystal molecules is substantially parallel to the binocular direction H1 linking both eyes of the user, the reflectivity is improved. The size of the lateral direction, for example, the binocular direction H1 of the liquid crystal display element, may be large. In this case, when the user views the liquid crystal display element, the user may tilt their head slightly.

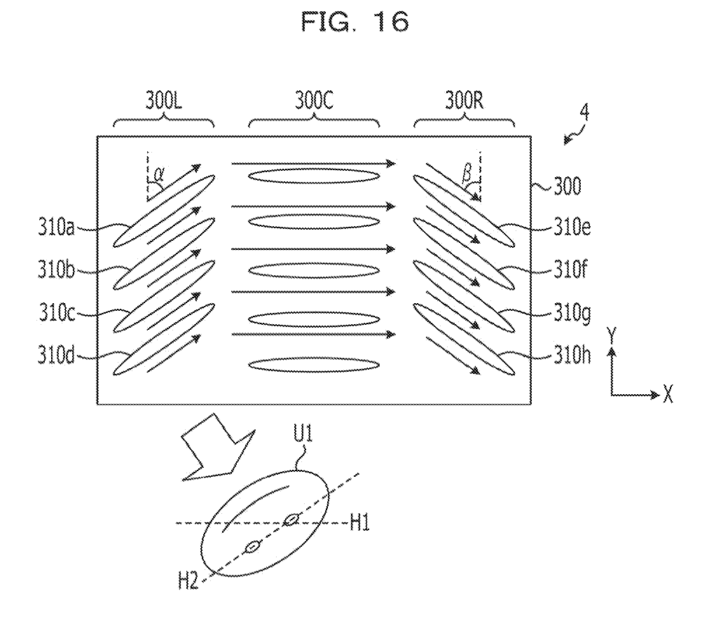

FIG. 16 illustrates an exemplary liquid crystal display element. A liquid crystal layer 300 illustrated in FIG. 16 may correspond to a cross-sectional view parallel to a display surface. The size of the lateral direction, for example, the binocular direction H1 of the liquid crystal display element 4 illustrated in FIG. 16, may be large.

The liquid crystal layer 300 illustrated in FIG. 16 includes a first side section 300L, a central section 300C and a second side section 300R. The first side section 300L and the second side section 300R are located on both sides of the liquid crystal layer 300 when the binocular direction H1 is the lateral direction of the figure. The central section 300C is located on the center of the liquid crystal layer 300 when the binocular direction H1 is the lateral direction of the figure.

In the first side section 300L and the second side section 300R, structures 310a to 310h are formed so that an angle with the binocular direction H1 becomes a desired angle. For example, the angle of the first side section 300L may be an angle β and the structures may be formed in a direction to the second side section 300R. For example, the angle of the second side section 300R may be an angle β and the structures may be formed in a direction to the first side section 300L. The angles α and β are greater than 0 degrees and may be less than 90 degrees. The angle α and the angle β may be equal.

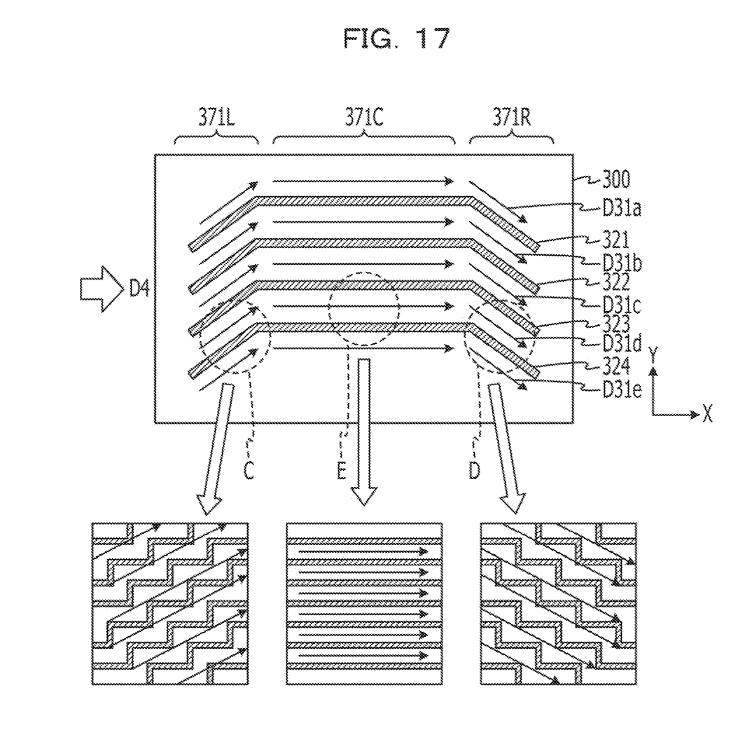

FIG. 17 illustrates an exemplary alignment direction of liquid crystal molecules. The liquid crystal molecules illustrated in FIG. 17 may be included in the liquid crystal layer 30 illustrated in FIG. 16. As illustrated in the upper side of FIG. 17, the liquid crystal layer 300 includes structures 321 to 324. Cholesteric liquid crystals are injected into the liquid crystal layer 300 in a direction D4 illustrated in FIG. 17. For example, the flow direction of the cholesteric liquid crystals may be directions D31a to 31e illustrated in FIG. 17. As illustrated in FIG. 16, the alignment direction of the liquid crystal molecules 310a to 310h included in the liquid crystal layer 300 may be substantially equal to the flow direction D31a to 31e of the cholesteric liquid crystals.

The lower side of FIG. 17 is an enlarged diagram of sections C to E illustrated in the upper side of FIG. 17. The structures 321 to 324 included in the first side section 300L and the second side section 300R may include a combination of an X-direction structure and a Y-direction structure.

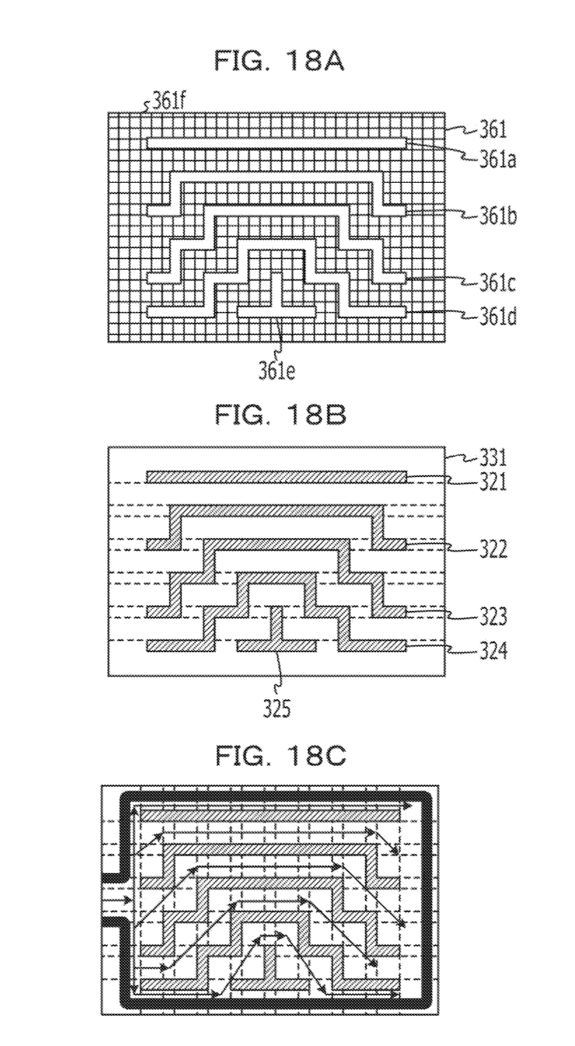

A method of manufacturing the liquid crystal display element 4 illustrated in FIG. 16 may be substantially equal or similar to the manufacturing method illustrated in FIG. 5. The shape of the photomask used in the operation S103 may be different. FIGS. 18A to 18C illustrate an exemplary photomask and an exemplary liquid crystal layer. FIG. 18A illustrates a photomask 361 used to manufacture the liquid crystal display device 4 illustrated in FIG. 16. FIGS. 18B and 18C illustrate a film substrate 331 of the liquid crystal display element illustrated in FIG. 16. The viewing direction of the arrow of the film substrate 331 illustrated in FIG. 18B may be equal to that of the film substrate 131 illustrated in FIG. 8. In addition, the viewing direction of the arrow of the film substrate 331 illustrated in FIG. 18C may be equal to that of the film substrate 132 illustrated in FIG. 11.

As illustrated in FIG. 18A, the photomask 361 includes light transmission portions 361a to 361e and a light shielding portion 361f. When the liquid crystal display element 4 illustrated in FIG. 16 is manufactured, the structures 321 to 325 illustrated in FIG. 18B may be formed using the photomask 361 illustrated in FIG. 18A. For example, as illustrated in FIG. 18C, when cholesteric liquid crystals are injected into the liquid crystal layer 300, the flow direction of the cholesteric liquid crystals is set.

In the liquid crystal display element 4 illustrated in FIG. 16, the alignment direction of the liquid crystal molecules on both side sections of the liquid crystal layer 300 is inclined with respect to the binocular direction H1. Therefore, in the liquid crystal display element 4 illustrated in FIG. 16, reflectivity may be improved even when the size of the lateral direction, for example, the direction X, of the liquid crystal display element is large and the user views the liquid crystal display element while tilting his or her head. Since the alignment direction of the liquid crystal molecules on both side sections is inclined, even when the user views both side sections of the liquid crystal display element while tilting his or her head, the alignment direction of the liquid crystal molecules is parallel when viewed from the user.

For example, as illustrated in FIG. 16, the user U1 may view the first side section 300L while tilting his or her head. The binocular direction H2 linking both eyes of the user U1 whose head tilts and the alignment direction of the liquid crystal molecules 310a to 310h located on the first side section 300L may become parallel to each other. The reflectivity and the contrast ratio of the liquid crystal display element 4 illustrated in FIG. 16 may be improved.

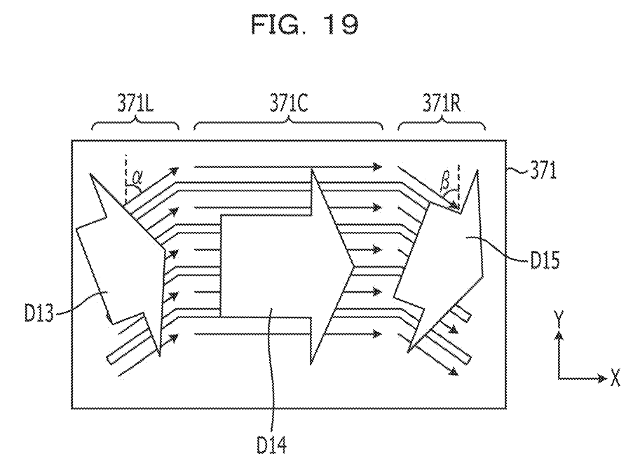

The rubbing process may be performed on the alignment film used in the liquid crystal display elements 4 illustrated in FIG. 16 in substantially the same direction as the flow direction of the cholesteric liquid crystals. FIG. 19 illustrates an exemplary rubbing process. The rubbing process illustrated in FIG. 19 may be performed on the alignment film 371 illustrated in FIG. 16. As illustrated in FIG. 19, in section 371L corresponding to the first side section 300L of the liquid crystal layer 300 illustrated in FIG. 17 of the alignment film 371, an angle with the binocular direction H1 may be an angle α. The rubbing process may be performed in a direction D13 to a section 371R corresponding to the second side section 300R. In a section 371R corresponding to the second side section 300R of the liquid crystal layer 300 illustrated in FIG. 17 of the alignment film 371, an angle with the binocular direction H1 may be an angle β. The rubbing process may be performed in a direction D15 to a section 371L corresponding to the first side section 300L. In a section 371C corresponding to the central section 300C of the liquid crystal layer 300 illustrated in FIG. 17 of the alignment film 371, the rubbing process may be performed in a direction parallel to the binocular direction H1.

The flow direction of the cholesteric liquid crystals at the time of injection is set using the structures. The flow direction of the cholesteric liquid crystals at the time of injection may be set without using the structures.

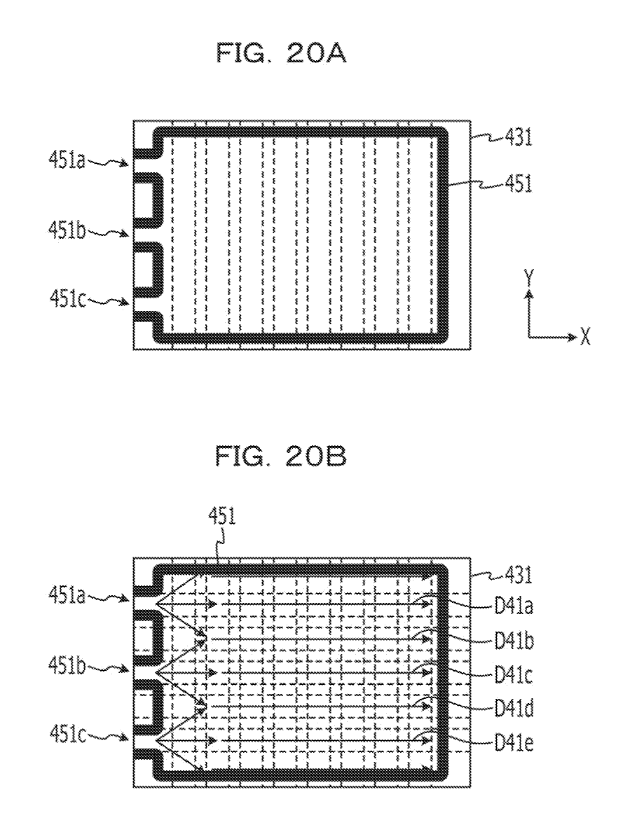

FIGS. 20A and 20B illustrate an exemplary liquid crystal display element. As illustrated in FIG. 20A, in a liquid crystal display element 5, a sealing agent 451 is applied to a film substrate 431 in a manufacturing operation. The sealing agent 451 is applied to the film substrate 431 such that a plurality of liquid crystal injection ports 451a to 451c is formed. The liquid crystal injection ports 451a to 451c are formed on a side section of the film substrate 431 with a specified gap between the ports when the binocular direction H1 is the lateral direction of the figure.

The cholesteric liquid crystals injected into the liquid crystal injection ports 451a to 451c flow along the flow direction D41a to D41e illustrated in FIG. 20B. Since the flow direction of the cholesteric liquid crystals and the alignment direction of the liquid crystal molecules are substantially equal, as illustrated in FIG. 20B, the flowing cholesteric liquid crystals may be substantially parallel to the binocular direction H1.

In the liquid crystal display element 5 illustrated in FIG. 20, the plurality of liquid crystal inject ports is formed and the flow direction of the cholesteric liquid crystals at the time of injection is set by the locations of the liquid crystal injection ports. In the liquid crystal display element 5 illustrated in FIG. 20, structures setting the flow direction of the cholesteric liquid crystals may not be formed.

Example embodiments of the present invention have been described in accordance with the above advantages. It will be appreciated that these examples are merely illustrative of the invention. Many variations and modifications will be apparent to those skilled in the art.

1. A liquid crystal display element comprising:
a liquid crystal layer including liquid crystal material reflecting light having a certain wavelength; and
an electrode layer configured to apply a driving voltage to the liquid crystal material,
wherein an alignment direction of first liquid crystal molecules of the liquid crystal material is a first direction substantially parallel to a liquid crystal display surface.

2. The liquid crystal display element according to claim 1, wherein the liquid crystal layer includes a plurality of structures arranged in a second direction perpendicular to the first direction.

3. The liquid crystal display element according to claim 2, wherein each of the plurality of structures includes a plurality of protruding sections arranged in the first direction.

4. The liquid crystal display element according to claim 1, further comprising:
an alignment film provided between the liquid crystal layer and the electrode layer.

5. The liquid crystal display element according to claim 1, wherein the liquid crystal layer includes second liquid crystal molecules aligned in a direction having an angle with a third direction perpendicular to the first direction.

6. A method of manufacturing a liquid crystal display element, the method comprising:
forming a transparent conductive film on surfaces of a first substrate and a second substrate;
forming a plurality of structures on the transparent conductive film on the first substrate in a first direction substantially parallel to a liquid crystal display surface;
adhering the second substrate to the first substrate so as to face a surface having the plurality of structures of the first substrate; and
injecting liquid crystal material between the first substrate and the second substrate.

7. The method according to claim 6, wherein the plurality of structures include photoresists and are formed using a photomask.

8. A liquid crystal display device comprising:
a plurality of liquid crystal display elements laminated,
Wherein each of the plurality of liquid crystal display elements includes:
a liquid crystal layer including liquid crystal material reflecting light having a certain wavelength; and
an electrode layer configured to apply a driving voltage to the liquid crystal material,
wherein an alignment direction of first liquid crystal molecules of the liquid crystal material is a first direction substantially parallel to a liquid crystal display surface.

9. The liquid crystal display device according to claim 8, wherein the plurality of liquid crystal display elements reflect respective light having a different wavelength.
